(19) United States
(12) Patent Application Publication
(10) Pub. No.: US 2007/0046459 A1
(43) Pub. Date: Mar. 1, 2007

(54) METHODS AND APPARATUS FOR ASSET TRACKING

(75) Inventors: Shmuel Silverman, Buffalo Grove, IL (US); Hafid Hamadene, Forest Park, IL (US); Nicholas C. Hopman, Lake Zurich, IL (US); Emanuel Kahana, Chicago, IL (US); Ron Rotstein, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/458,507

(22) Filed: Jul. 19, 2006

Related U.S. Application Data
(60) Provisional application No. 60/712,767, filed on Aug. 31, 2005.

(51) Int. Cl. G08B 1/08

(52) U.S. Cl. 340/539.13

(57) ABSTRACT

A method for enabling asset tracking that includes the steps of: receiving (910) a first excitation signal at a first power level using a first frequency band; and (920) upon determining that a first set of parameters is satisfied, awakening from an inactive mode to an active mode, transmitting data at a second power level that is greater than the first power level using a second frequency band that is different from the first frequency band, and returning to the inactive mode, wherein determining that the first set of parameters is satisfied comprises at least determining that the first excitation signal corresponds to a first wake-up circuit.

### FIELD OF THE INVENTION

The present invention relates generally to asset tracking and more specifically to methods and apparatus for efficiently enabling asset tracking in an environment having a plurality of tags, some of which may be moving and may be in close proximity to other tags.

### BACKGROUND OF THE INVENTION

Today there exist a number of use case scenarios and corresponding tag device and reader device subsystem requirements for tracking assets such as, for instance, containers that may be transported on vehicles to and from a storage location or facility. In a first illustrative use case, assets with tag devices coupled thereto enter and exit a gate near an observation point typically at a speed of about twenty miles per hour (MPH) or less, and there is a high concentration of assets near the observation point. In this first use case, a tag device (also referred to herein as a tag) and reader device (also referred to herein as a reader) subsystem should meet the minimum requirements of detecting assets that are entering and exiting the gate during a transition of the assets from inside to outside the gate or from outside to inside the gate, without detecting the assets that are near the observation point. In a second illustrative use case, there is a high concentration of assets near an observation point, and the assets are relatively static to a reader device at the observation point. In this second use case, a tag device and reader device subsystem should meet the minimum requirements of tracking all of the assets or a portion thereof while maximizing the battery life of the tag devices coupled to those assets being tracked.

Thus, there exists a need for a tag device and reader device subsystem and corresponding methods that satisfy the minimum system requirements for the above use case scenarios to enable efficient and effective asset tracking: while some tags are moving with respect to a reader device/observation point; at low transmit power; and at difficult propagation among dense tag device populations, all while maximizing battery life and minimizing cost in tag devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an asset tracking system in accordance with embodiments of the present invention;

FIG. 2 illustrates a tag device and reader device subsystem of the tracking system illustrated in FIG. 1;

FIG. 3 illustrates a more detailed downlink transmit and signaling sequence in accordance with embodiments of the present invention;

FIG. 4 illustrates a propagation delay between a reader device and a tag device in accordance with embodiments of the present invention;

FIG. 5 illustrates a pseudo-noise offset from a reader device perspective in accordance with embodiments of the present invention;

FIG. 6 illustrates a downlink transmit signaling sequence using multiple wake-up signals in accordance with embodiments of the present invention;

FIG. 7 illustrates a flow diagram of a method for enabling asset tag tracking in accordance with embodiments of the present invention;

FIG. 8 illustrates a state diagram for a tag device in accordance with embodiments of the present invention;

FIG. 9 illustrates a tag device state change decision flow in accordance with embodiments of the present invention;

FIG. 10 illustrates security processing in a tag device in accordance with embodiments of the present invention;

FIG. 11 illustrates a tag device receiver structure and functionality in accordance with embodiments of the present invention;

FIG. 12 illustrates a tag device transmitter structure and functionality in accordance with embodiments of the present invention; and

FIG. 13 illustrates a reader device receiver structure and functionality in accordance with embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for asset tracking. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for asset tracking described herein. The non-processor circuits may include, but are not limited to, a radio receiver, a radio transmitter, signal drivers, clock circuits, power source circuits, and user input devices. As such, these functions may be interpreted as steps of a method to perform the asset tracking described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, a tag device and reader device subsystem and methods for enabling asset tracking are described. Usually, the tag devices will be in an inactive state and a reader device within an infrastructure awakens the tag devices only when necessary. The reader device transmits excitation signals that are received and may be acted upon by one or more tag devices that are each coupled to an asset to enable the asset to be tracked. Responsive to an excitation signal, the tag device determines whether to awaken from an inactive mode to an active mode to transmit data to the reader device.

An excitation signal is received by a tag device at a first power level and using a first frequency band, e.g., an 800 or 900 MHz unrestricted frequency band with higher allowed power rules, and any data transmitted by the tag is transmitted at a second power level that is greater than the first power level using a second frequency band that is different from the first frequency band and that may be lower than the first frequency band, e.g., a 433 MHz restricted frequency band. Using an unrestricted frequency band to transmit the excitation signals enables the use of sufficient power for the tag devices to detect the excitation signals, and use of a restricted band for responsively transmitting data from the tag devices to the reader devices help to conserve battery life in the tag devices.

The tag devices may comprise a plurality of wake-up circuits that may be used in conjunction with an instruction signal from a reader device to control which wake-up circuit is used to awaken the tag. This facilitates conservation of battery life in the tag devices. The tag devices may further comprise a random number generator process to limit the number of times a tag device will awaken to the active state even upon receiving the proper excitation signal, to decrease the incidence of interference between tags that are attempting to transmit data to a reader device and to, thereby, further conserve battery life in the tag devices. Those skilled in the art will realize that the above recognized advantages and other advantages described herein are merely exemplary and are not meant to be a complete rendering of all of the advantages of the various embodiments of the present invention.

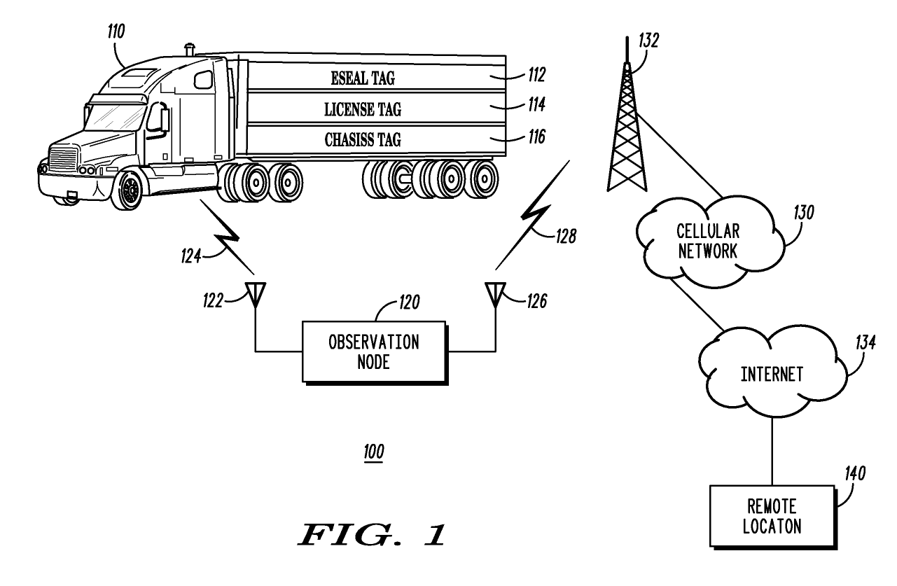

Referring now to the drawings, and in particular FIG. 1, a system for enabling asset tracking in accordance with embodiments herein is shown and indicated generally at 100. Illustrated therein is a vehicle 110 that may transport one or more assets such as containers (not shown). The vehicle may have coupled thereto, using any suitable method, one or more tag devices, in accordance with embodiments herein, for tracking the vehicle and/or the assets thereon. The tag devices may include: one or more E-Seal tags 112 to verify sealing of all or a portion of the containers, for instance by a trusted authority; one or more license tags 114, 116 that may serve as unique identifiers for the vehicle, the vehicle chassis (e.g., using a chassis tag 116) and/or the containers on the chassis; and one or more telemetry tags (not shown) for monitoring parameters such as container temperature, and other parameters or attributes. In order for the vehicle 110 and/or the assets to be tracked or monitored, the vehicle may drive into the vicinity of an observation node or point 120 that comprises a reader device (not shown), in accordance with embodiments herein. The observation node may, for example, be located on a highway, at or near a gate to a storage location or facility or within a storage facility such as a building or a yard.

The reader device may transmit one and typically many excitation signals via an antenna 122 on a link 124, e.g., a radio frequency (RF) link, that may be received, for example, by one or more of the tags (e.g., 114) coupled to the containers on the vehicle 110. An excitation signal is generally a RF signal at a frequency and power level necessary and sufficient to trigger at least one wake-up circuit in a tag device that is in an inactive mode or state to awaken to an active mode or state. A tag device is in an active mode when it is preparing to transmit and is actually transmitting data to a reader device. Otherwise the tag may be considered to be in an inactive mode. In response to a proper excitation signal (and in some embodiments when one or more additional parameters are met) the tag device(s) may transmit data on link 124 to the reader device comprising observation node 120. This data may include such information as, for example, a unique identification number or other information to uniquely identify the asset, or electronic telemetry (or any other type of measured or assigned data), but is not limited to such information. Moreover, the data may be transferred from the observation node 120 to a remote location 140, for instance a gateway or server, which collects and/or analyzes information about tracked assets. For example in one embodiment, the data may be transmitted via an antenna 126 on a link 128, e.g., an RF link, to a cellular base station 132 of a cellular network 130 and further communicated over the Internet 134 to the remote location 140.

Those skilled in the art, however, will recognize and appreciate that the specifics of this illustrative example are not specifics of the invention itself and that the teachings set forth herein are applicable in a variety of alternative settings. For example, since the teachings described do not depend on the particular architecture of system 100, they can be applied to any type of system architecture that includes a tag device in communication with a reader device implementing the various teachings described herein.

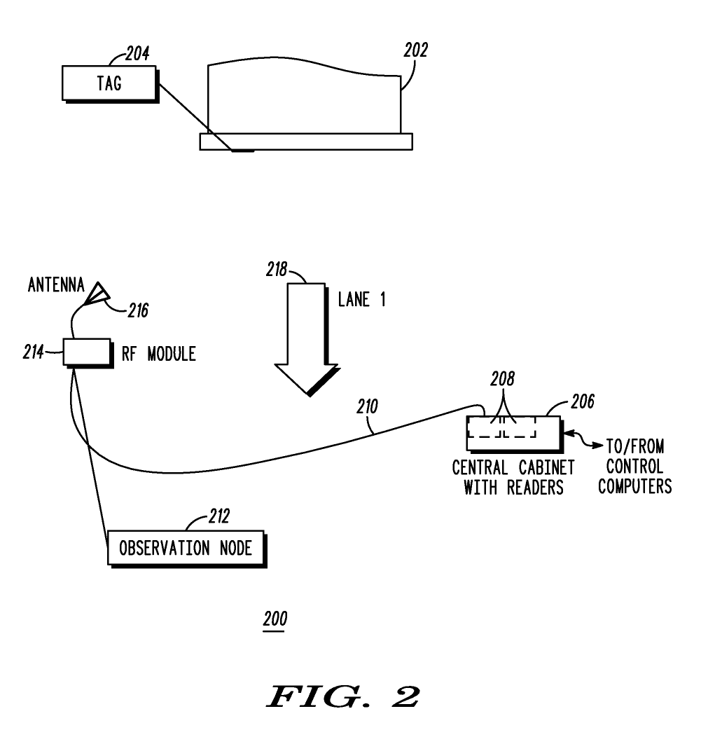

Turning now to FIG. 2, an illustrative tag device and reader device subsystem that may be implemented in asset tracking system 100 is shown and generally indicated at 200. In general, subsystem 200 comprises one or more tag devices 204 (only one shown for ease of illustration) and one or more reader devices 208 (only two shown for ease of illustration) having respective architectures and functionality in accordance with the teachings herein for enabling efficient tracking and/or monitoring of assets (e.g., a container 202 to which tag 204 is attached). Both the tags and the readers have suitable transmit and receive circuitry and may have additional circuitry for implementing the various embodiments described herein. The reader devices 208 may be strategically geographically located to detect, for instance, the presence of, direction of travel and/or relative position of one or more tag devices 204.

In one embodiment, one or more observation nodes 212 (only one shown for ease of illustration) for detecting tag devices may be located at a gate entrance to an asset storage facility. An observation node comprises an RF module 214 for modulating excitation signals at one or more predetermined frequencies and for demodulating data from a tag device. The observation node further comprises at least one suitable antenna 216 for use in receiving RF signals containing data from tag devices and transmitting the excitation signals. The observation node also comprises at least one reader device 208 that generates the excitation signals and reads or decodes the received tag data and may further communicate that data to other locations such as to computers at remote locations.

In one embodiment, the reader may transmit excitation signals to a tag device using (e.g., within) a 800 or 900 MHz unrestricted frequency band that has higher allowed power rules, wherein the excitation signals are received at the tag devices at a first power level. Any data transmitted from the tags to the reader is transmitted at a second power level that may be greater than the first power level using a lower frequency band, e.g., a 433 MHz restricted frequency band. Generally, the second power level used by the tags to transmit data to the reader is typically higher than the first power level at which the excitation signals are received at the tag devices because the tag devices use an internal power source to transmit their information. This enables transmissions from the tag devices to the reader device to be implemented, e.g., up to 600 meters.

Using an unrestricted frequency band to transmit the excitation signals to the tag devices enables the use of sufficient transmit power for the tag devices to detect the excitation signals, since the tags may have passive wake-up circuitry that is powered by the excitation signal. Using a restricted band for responsively transmitting data from the tag devices to the reader devices helps to conserve battery life in the tag devices. However, those of ordinary skill in the art will realize that the above-described frequency bands are merely exemplary, and that other suitable frequency bands for both transmitting excitation signals from the readers to the tags and for transmitting information from the tags to the readers are within the scope of the various teachings herein.

In the embodiment illustrated, the reader device 208 comprising the observation node is housed at a central location (e.g., a cabinet 206) with other reader devices, such that the reader device 208 is physically remote from the RF module 214 and antenna 216 of observation node 212 but coupled to the RF module 214, for example, using a buried cable 210. It should be understood by those of ordinary skill in the art, however, that in other embodiments, the reader 208 may be co-located with the RF module 214. Moreover, it should be further understood by skilled artisans that a typical gate may comprises a plurality of lanes 218 through which vehicles carrying tagged assets may pass in and out of the gate and that an observation node may be located at each lane to detect the tags that may be coupled, for example, to the front of a vehicle chassis or somewhere on containers sitting on the chassis.

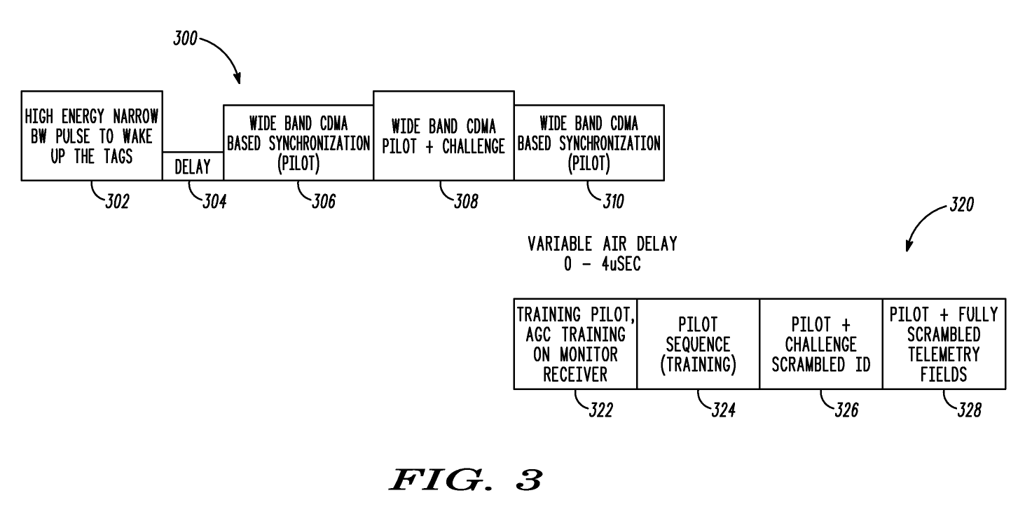

The tag/reader subsystems implemented in accordance with the teachings herein may be described as comprising two distinct links, a “downlink” from the observation node/reader device to the tags and an “uplink” from the tags to the observation node/reader device. Usually, the downlink is a one (reader) to many (tags) link and may comprise a broadcast signal or message common to any tags within a given receive radius of the reader. However, the uplink is usually many (tags) to one (reader). FIG. 3 is a timing diagram that illustrates a reader's downlink transmit signaling sequence 300 and an exemplary uplink reply 320 from a single tag. It should be understood by skilled artisans, of course, that there may be hundreds or thousands of replies such as 320 to a single reader transmission but that only one such reply 320 is shown for simplicity and ease of illustration.

Sequence 300 is employed by a reader device to transmit signals to a plurality of tags. The first thing to be sent is a narrowband “wake up” sequence 402 that may be a pulse and which also referred to herein as to excitation signal. In order to have a very long battery life, tags spend almost all the time in a very low power mode characterized by a complete absence of power consumption other than leakage current as is common to all electronic devices. The wake up sequence is used to turn on the power in the tag, which may be done through a narrowband, high Q circuit in a hardware receiver as explained in more detail in the text below. Once the wake up sequence 302 is sent a small amount of time 304 is allowed to elapse while the tags ready themselves to receive a data transmission from the reader.

Data transmission from the reader begins with a synchronization sequence 306, which in one embodiment is a Code Division Multiple Access (CDMA) pilot pattern. After a reasonable synchronization time as is well known in the art, a security challenge 308 is sent in one embodiment by adding a second CDMA pattern to the existing CDMA pilot pattern. The security challenge 308 may contain at least several bytes of random test that may be used along with a secret password, stored in each tag and unique to each tag, as input to a standard challenge/response authentication algorithm, such as the Radius algorithm described in Internet Engineering Task Force Request for Comment 2865. Additional commands from the reader may follow the security challenge instructing the tags to, for example, respond with their unique identifiers.

It generally takes some amount of time for the radio transmission to travel from the reader to the tags, typically between zero and four microseconds. The tags then reply 320 by first sending a pilot sequence 322 that allows the reader to adjust its receiver gain control, followed by a pilot sequence 324 that allows the reader to synchronize its data recovery circuit to the tag transmission 320, followed by the reply 326 to the security challenge which is sent by adding a second CDMA pattern to the pilot pattern, and finally, data field 328 from the tag that may include among other things the tags unique identifier and telemetry data. It should be appreciated by those of ordinary skill in the art that in the above-described embodiment corresponding to FIG. 3, the tag and reader transmission sequences are described for a code division access system. However, the teachings herein apply equally to other access systems, such as time and frequency division access systems, or combinations of these access systems.

As stated above, any given downlink excitation signal may typically initiate a response from a plurality of tags (e.g., in the hundreds or thousands). Thus, a method is desirable for differentiating the responses of the various tags. It would be a simple solution to assign a unique channel, such as a frequency, time slot, code sequence, etc., or combination of one or more of those to every tag in the system. However, such a solution would be impractical in systems where there are millions of tags, for instance, and only limited spectral allocation, as is the case in typical systems. Alternatively, a method may be implemented that identifies M tags which are randomly assigned to N channels, where M>>N (for example on the order of 10-100).

Typically in such a system, the reader instructs all the tags within its transmission range to transmit their data back to the reader. Since it is impractical for the tags to each have a unique channel they must share a smaller number of channels. In this case, the reader instructs all the tags within its transmission range or transmission radius as to the range of channels available using a broadcast message and each tag randomly chooses a channel from that range. Queuing theory has shown that the best throughput efficiency occurs when the number of channels available equals the number of tags that respond. It should be understood by skilled artisans, if the number of channel available is lower than the number of tags, tag transmissions will occur and retransmission will be required, which reduces efficiency. Moreover, the greater the number of channels available, the less chance of tag transmission occurring on any given channel, which increases the number of idle channels and also correspondingly reduces efficiency. When the number of channels equals the number of tags the channel efficiency becomes 1/e, or 36.79%, the familiar maximum efficiency of a slotted Aloha channel. Thus it benefits efficiency if the number of channels provided can be made substantially equal to the number of tags within the transmission range of the reader.

A problem exists in initially determining the number of tags within the transmission range of the reader. In this case, a random number process may be used to determine the number or approximate number of tags within its transmission radius in order to adjust the number of channels used to optimize tag transmission throughput. An illustrative random number process is described below. In such and embodiment, a broadcast command may be sent from the reader asking all the tags within its transmission range to draw a random number in some range, for example from one to ten, and if that number is one, to draw a random number within a second range, for example from one to one hundred, and transmit a data packet on the channel number given by the second random number. In this case, substantially 10% of the tags will respond and the reader will be able to estimate the number of tags within its transmission range.

The range of the second random number is chosen to be, in one embodiment, about three times high than the maximum number of tags expected divided by 10. Doing this there is only a small probability that the number of tags detected is significantly affected by collisions. The reader may attempt to detect collision by examining each channel to determine if power was sent on a channel but a data packet not received. If this occurs the reader can decrease the first random number and increase the second random number and try the process again, thus determining the number of tags within the transmissions range of the reader. Once the number of tags is known, the number of channels used by the reader can be adjusted to optimize tag throughput in response to each excitation signal.

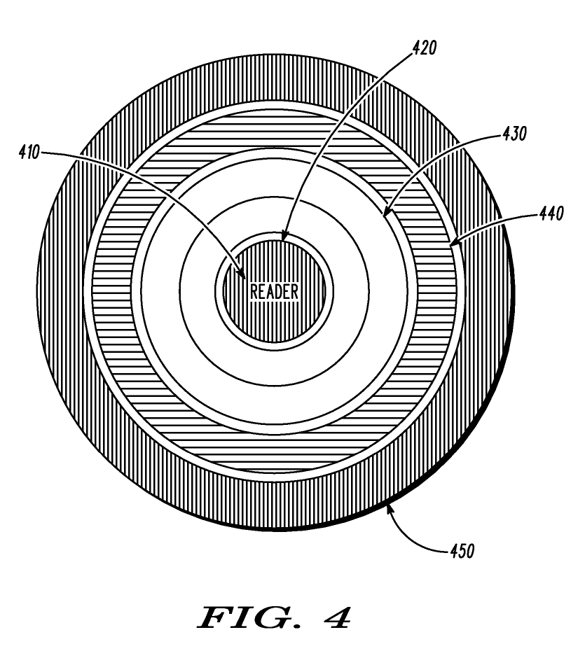

In one illustrative embodiment of a container tracking system, a plurality of tags may be distributed in an entire coverage radius of a reader device (e.g., a reader device transmission or transmit radius) of 600 meters, for example. Consequently as mentioned above, one or more tags may see a downlink excitation signal at a slightly different time, and response information from the tags may correspondingly be received at the reader receiver at different times. FIG. 4 illustrates a graphical representation of different propagation induced delays from a reader device to a plurality of tag devices, which are at different distances from the reader device.

In this illustration, a reader device may be positioned at a location 410. Tags included in a first set of tags may be positioned within a location range 420, e.g., of between 0 and 150 meters from the reader, corresponding to a propagation delay range, e.g., of between 0 and 1 μSec. Tags included in a second set of tags may be positioned within a location range 430, e.g., of between 150 and 300 meters from the reader, corresponding to a propagation delay range, e.g., of between 1 and 2 μSec. Tags included in a third set of tags may be positioned within a location range 440, e.g., of between 300 and 450 meters, corresponding to a propagation delay range, e.g., of between 2 and 3 μSec. Tags included in a fourth set of tags may be positioned within a location range 450, e.g., of between 450 and 600 meters, corresponding to a propagation delay range, e.g., of between 3 and 4 μSec.

Where the excitation signals are transmitted using an 800 and/or 900 MHz frequency band, a CDMA multiplexing technology may be used, for instance. Traditional CDMA assumes N orthogonal channels using Walsh Codes. However, such a system is limited because orthogonality is maintained only for perfectly synchronized codes. Orthogonality is lost where there are time delays exceeding ¼ chip duration (˜300 nsec). Thus, in accordance with the various embodiments described herein special filters may be applied to othogonalize pseudo-random noise (PN) codes of the Maximum-length code (MLC) type. These codes are cyclical, therefore are not sensitive to delays. One embodiment uses a single 256 long MLC sequence, and sixteen (16) virtual channels may be created by shifting the sequence (using as 16 chip shift distance), which is generally much greater than the propagation delay between tags.

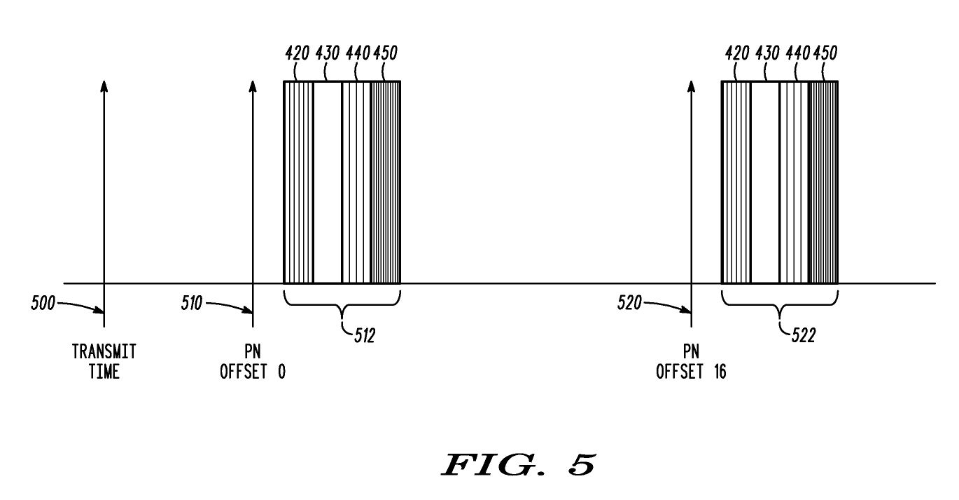

A PN domain view is illustrated in FIG. 5 that corresponds to FIG. 4, where each main offset exhibits a 4 uSec delay, for example, due to air propagation artifacts. Shown therein is a reader transmit time 500, a PN offset zero (510) and a PN offset sixteen (520). Total propagation delays 512 and 522, respectively at PN offsets zero and sixteen, reflect the sum of the propagation delay ranges corresponding to the location ranges 420, 430, 440 and 450 of tag devices from the reader device as illustrated in FIG. 4.

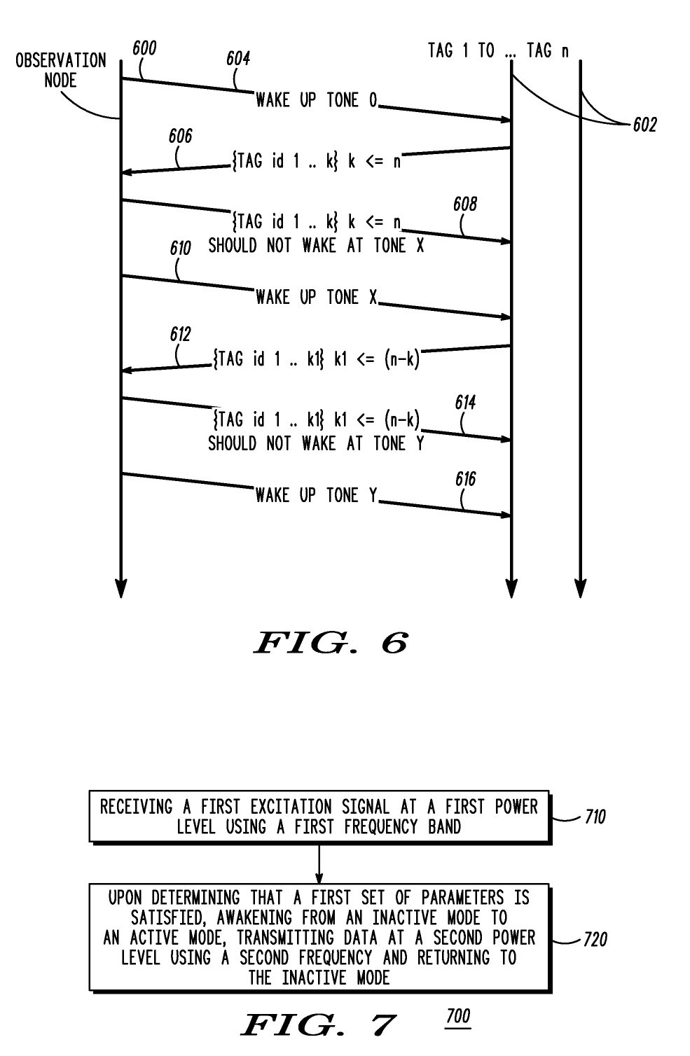

When one or more tags has transmitted data in response to an excitation signal and this data has been received and processed at an observation node, it may be desirable to have these tags remain in an inactive state upon additional excitation signals being transmitted by the observation node, so as to conserve battery life in those tags. FIG. 6 illustrates an embodiment, wherein downlink transmit signaling using multiple wake-up signals or tones is implemented to prevent tag devices from awakening in certain instances. Illustrated in FIG. 6 is a single observation node 600 and multiple tags (e.g., 1 to n) 602. Let us assume, for example, that the observation node desires to poll or scan all of the tags within its transmit radius. On a first transmission pass (e.g., a first pass), observation node 600 may transmit (e.g., via a broadcast message) a first excitation signal 604 (e.g., a wake-up tone or wake-up signal 0). At least a portion of the tags 602 (or perhaps all of the tags 1 to n) may receive excitation signal 604, and responsively awaken to an active mode and transmit their respective data to the observation node 600. For example, excitation signal 604 may correspond to a power level and/or frequency band that triggers a corresponding first wake-up circuit in the responding or transmitting tags.

Generally, observation node 600 will only have sufficient capacity to “hear” or decode the data from some of the transmitting tags 602, e.g., tags having identifications 1 to k, where k may be less than (usually) or equal to n (as illustrated by arrow 606). Where k is less than n, the observation node may during a second transmission pass transmit another excitation signal 610 (e.g., a wake-up tone x). Excitation signal 610 may be different from excitation signal 604, for instance, in that excitation signal 610 is in a different frequency band than excitation signal 604 and corresponds to a power level and/or frequency band that triggers a corresponding second wake-up circuit in responding tags that is different from the first wake-up circuit. Illustrative responding tags may comprise, e.g., tags having identifications 1 to k1, where k1 is less than or equal to (n−k) as illustrated by line 612.

In one embodiment, reader device 600 may transmit excitation signal 604 using a 800 MHz frequency band (e.g., 800-810 MHz) to awaken a first wake-up circuit in the tag devices 602, and may transmit excitation signal 610 using an 800 or 900 MHz frequency band (e.g., 810-820 MHz or 900-910 MHz) to awaken a different second wake-up circuit in the tag devices. It should, however, be understood by those skilled in the art that the number of different wake-up tones (and corresponding frequency bands and wake-up circuits) used may depend upon the number of tag devices in the system and, more particularly, how many tag device may typically be located within the transmit radius of each reader device.

To limit the number of tags that transmit data in response to excitation signal 610, observation node 600 may transmit an instruction signal 608 (also referred to herein as a “mask”) to a portion of the tags. For example, observation node 600 may transmit an instruction signal 608 to tags 602 having identifications 1 to k that were heard by the observation node during the first pass. The instruction signal may cause these tags to select one of a plurality of wake-up circuits (e.g., the first wake-up circuit) to awaken the tags to transmit data and to effectively inactivate the rest of the plurality of wake-up circuits comprising these tags.

Alternatively, the reader may, through a single broadcast message for instance, instruct all the tags within its transmitter range to randomly pick a mask value from a range of mask values, say, one to ten, using a random number generator internal to the tag. This allows the tags to be segregated into substantially uniform groups of, in this case, one tenth the size of the overall population. The advantage of this method is that nothing about the tag population, such as the number of tags within range of the reader or the unique identification numbers of the tags, needs to be known in advance, and one relatively compact broadcast message causes a large population of tags to adopt masks. The masks could stay in effect until a new mask command was sent or a time out time had lapsed. The time out time could, in one embodiment, be sent from the reader as part of the original mask message, which included the range of mask values from which the random number generator should draw.

In one implementation the instruction signal 608 may comprise information regarding a preferred wake-up state, for example if the mask comprises an ON bit corresponding to a given wake-up tone (and corresponding wake-up circuit), then the tag receiving the mask may awaken to an active state only upon receipt of that tone. Conversely, if the mask comprises an OFF bit corresponding to a given wake-up tone (and corresponding wake-up circuit), then the tag receiving the mask may remain in an inactive state upon receipt of that tone. Typically, tags that have been heard would receive such a mask from the observation node prior to the observation node transmitting a subsequent tone to which those tags should not respond. The observation node may use known technologies to direct an instruction signal to the tags that the node has already heard since the node will typically have received identifying information regarding these tags.

By using the mask 608 to reduce the number of tags that respond to excitation signal 610, the tags receiving the mask 608 conserve battery life by remaining in an inactive state, since these tags have already been heard. Moreover, the observation node will generally only hear tags that have not yet been heard. Similarly, if there are still nodes remaining that have not been heard (as determined by the observation node 600, for instance, using a suitable methodology such as that described above), observation node 600 during a third transmission pass may transmit a third distinct excitation signal 616 (e.g., a wake-up tone y) and corresponding instruction signal 614 (e.g., a mask instructing tags having identifications 1 to k1 not to wake up to tone y and to only wake up to tone x, for example). The observation node may continue to transmit distinct wake-up tones and corresponding masks until it has detected all of the tags 602 in its transmission radius.

In yet another embodiment, the reader device may use a mask to limit tag response to tags that are entering through a given gate. In this embodiment, for example, prior to the arrival of a vehicle carrying assets having tags coupled thereto the reader may send a mask to other tags in its transmit radius instructing the tag devices not to awaken for a given wake-up tone. Then, the reader may transmit that given tone as an excitation signal to the tags on the vehicle to awaken those tags to transmit their data to the reader. A similar methodology may be followed for tracking tags on a vehicle leaving the gate.

Turning now to FIG. 7, a flow diagram of a method for enabling asset tag tracking in accordance with embodiments herein is shown and generally indicated at 700. Method 700 may be performed in a tag included in a tag device/reader device subsystem such as subsystem 200 described above by reference to FIG. 2. A tag device may comprise: one or more suitable antennas on which excitation signals may be received and tag data may be transmitted; a receiver circuit coupled to the antenna(s) and comprising one or more wake-up circuits as described in more detail below for receiving the excitation signals and awakening the tag from an inactive mode to an active mode; and a transmitter circuit coupled to the antenna(s) and to the receiver circuit for transmitting data while in the active mode and usually for causing the tag to return to the inactive mode upon completion of the data transmission. The tag device further comprises a memory for storing the data and may further comprise suitable logic for performing methods in accordance with embodiments herein, e.g., a random number generator process.

In accordance with method 700, in general, a tag may receive (710) an excitation signal at a first power level or energy using a first frequency band (e.g., within the 800 MHz frequency band). This first power level of the excitation signal or pulse received at the tag has a much lower power level (e.g., −60 dBm) than the excitation signal's power level (e.g., 0 dBm) as it left the reader. Upon determining (720) that a first set of one or more parameters is satisfied, the tag device may: awaken from an inactive mode to an active mode; transmit data at a second power level that is greater than the first power level (e.g., −40 dBm) using a second frequency band that is different from the first frequency band (e.g., 433 MHz); and return to the inactive mode, e.g. upon completion of the data transmission.

Determining that the first set of parameters is satisfied comprises at least determining that the received excitation signal corresponds to a wake-up circuit that may, in one embodiment, be one of a plurality of wake-up circuits. An excitation signal may correspond to a wake-up circuit where, for example, the tag detects that the received pulse is at a power level (e.g., a received energy that is above a predetermined power threshold (e.g., −60 dBm) that corresponds to the wake-up circuit and is received on a frequency band that is within a predetermined frequency range as determined, for instance, by one or more filters comprising the tag device (e.g., a filter comprising the wake-up circuit). Where the excitation signal is received on the required frequency band and exceeds the predetermined power threshold, the tag may awaken to the active mode, transmit data to the reader device on the second frequency band, and then return to the inactive mode to conserve power.

In another embodiment, the tag device may awaken to the active mode to transmit data when the received excitation signal is received on the required frequency band and is within a predetermined power range, e.g., −60 dBm to −40 dBm. Using an unrestricted frequency band for communicating the excitation signal enables a sufficiently powerful pulse to be transmitted that has enough energy such that when it is received by the tag devices at a much lower energy is has sufficient energy to trigger at least one wake-up circuit in a tag device. Using a restricted band for communicating data from the tag device to the reader device facilitates battery conservation in the tag device.

An illustrative wake-up circuit may comprise an antenna and a highly selective radio frequency filter tuned to the frequency of an expected wake-up signal. When within a predetermined range from the reader, the wake-up signal would have sufficient power that a voltage produced at the output of the RF filter, when detected using a well known RF detection circuit (in one embodiment a diode followed by a capacitor and resistor in a parallel configuration), would be sufficient to trigger a comparator circuit that can translate the RF voltage level to a digital logic level which could in turn cause a bi-stable device (commonly called a “flip-flop”) to latch and hold the detection of the wake-up signal and, as a result, cause the tag to enter its active mode. Later, of course, the bi-stable could be reset to the pre-detection state to enable the tag to revert to its inactive mode.

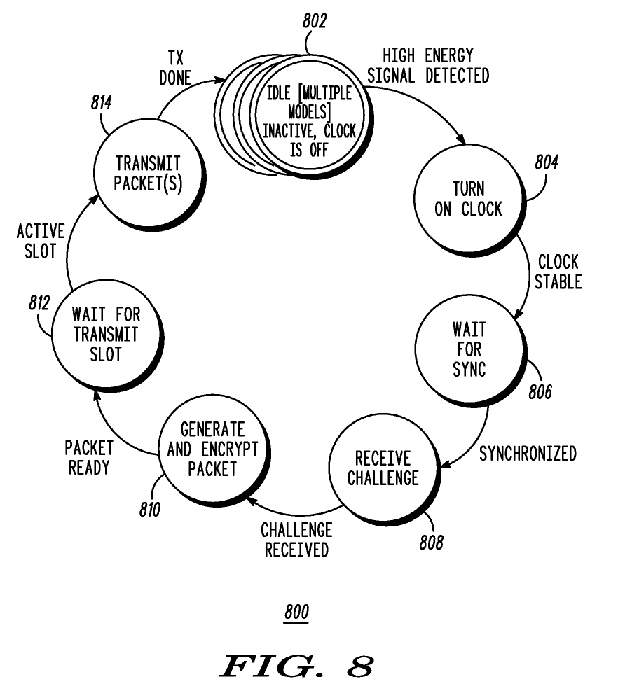

Turning now to FIG. 8, a state diagram for a tag device in accordance with embodiments herein is shown and generally indicated at 800. As can be seen from the state diagram, the tag is normally in an inactive (or idle) mode, wherein the clock is off. In this inactive mode, one or more wake-up circuits in the tag device may be in an inactive mode (e.g., also illustrated in FIG. 8 as multiple [idle or inactive] modes), and a low power high Q analog receiver is monitoring for a high power pulse on the 800 or 900 MHz frequency band. Once a sufficient pulse, as specified by a received energy above a known threshold, is detected, the receiver turns on the clock 804 (which may be the start of the active mode in one embodiment), waits for the systems (e.g., the clock) to stabilize and waits for a given, e.g., CDMA, synchronization (“SYNC”) pattern (806) on the same carrier (e.g., 800 or 900 MHz frequency band) where the energy pulse was detected. In one embodiment, if a SYNC is not detected within a predetermined time period, the receiver may return to an inactive state. However, if a SYNC is detected, the receiver may align its internal clock and timer to the sync, and move to the next state 808, of receiving a message containing a security challenge. Upon successful security authorization, the tag device may: generate and encrypt one or more packets (810) to transmit any required data or information; wait for a transmit slot (812) after at least a portion of the packets are ready to be communicated to the reader device; transmit the packets (814) on an available active slot; and return to the inactive mode.

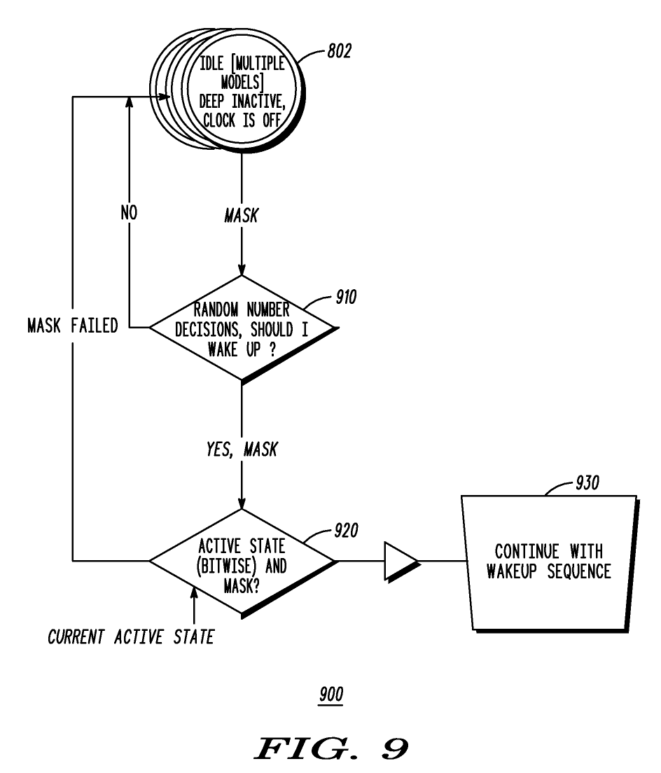

Returning for a moment to step 720 of FIG. 7, determining that the first set of parameters is satisfied may further comprise determining that the excitation signal corresponding to a wake-up circuit has been received at least a predetermined number of times as determined, for example, using a random number generator process implemented in the tag device. Moreover, determining that the first set of parameters is satisfied may further comprise determining that a given wake-up circuit corresponding to the received excitation signal has not been deactivated. FIG. 9 is illustrative of a tag device determining whether these two additional parameters have been satisfied.

Turning now to FIG. 9, a tag device state change decision flow in accordance with embodiments herein is shown and generally indicated at 900. Each tag may include one or more “passive” wake-up circuits that comprise its receiver. The wake-up circuits are referred to herein as passive because they are triggered to awaken from the inactive mode (802) to an active mode in response to an excitation signal from an infrastructure unit, e.g. an observation node/reader device. After awakening, the receiver activates a processing section that receives the excitation signal, expected mask, and security challenge. In this embodiment, the tag may continue with the wake-up sequence (930), e.g., by turning on its clock (804 of FIG. 8), when two conditions are met: the waking up state is a mandatory state (920); and after implementing a random number decision making process (910) it decides to continue.

The random number decision process 910 enables the tag to select a channel from a plurality of channels on which to transmit data, wherein the total number of channels may be optimized (using a suitable methodology as described above) based on the number of tag devices in a given reader transmit radius. This process reduces potential interference when many tags are packed into one area and many or all of them awaken all at once, for example. Since, the reader typically cannot receive and decode information from all of the potential responding tags at once, such a process gives the tags a better chance distribution to be heard.

Moreover, as briefly discussed above, a tag device may receive a mask (e.g., an instruction signal) from a reader device instructing the tag device as to a current active state. The instruction signal may indicate, for instance in a manner as is described above, one or more wake-up circuits that the tag should deactivate (so that the wake-up circuit(s) will not awaken the tag (e.g., the tag will remain in the inactive mode) even if the correct corresponding excitation signal is received the correct number of times. The instruction signal may further indicate, for instance in a manner as is described above, a wake-up circuit that should not be deactivated (e.g., a current active state) that will awaken the tag when the correct corresponding excitation signal is received. Thus, the tag may continue with its wakeup and reply mode when the current active state is part of the mask received with the excitation signal (e.g., where the mask does not fail). Otherwise the tag remains in its inactive mode.

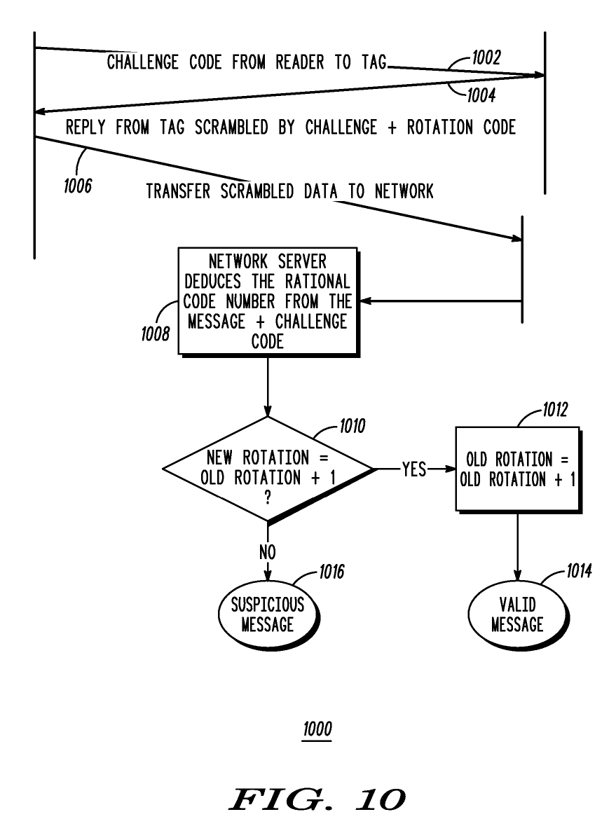

Turning now to FIG. 10, illustrative security processing in a tag device in accordance with the present invention is shown and generally indicated at 1000. In one embodiment, a process is based on a two message challenge-reply methodology, and a may be used in the tag to defend against record/replay attacks. The following described message exchange for security processing in accordance with FIG. 10 may be implemented in the tag device. In general, in order to protect against playback attacks, the infrastructure (e.g., an observation node/reader device) may issue a different challenge code (e.g., 1002) for every poll request. Inside each tag, there may be a circular counter that is used to generate a current Rotating Key. The infrastructure monitors this counter. Then, when the infrastructure receives one or more messages with data (1004), it finds what counter value has been used to scramble the data (1006, 1008). The farther the actual counter value is from the expected counter value, the more likely it is that the message is a spoof generated by a playback attack.

When a tag responds to a poll, it may scramble its identification (ID) using only a Challenge Key, while the body of the message (e.g., telemetry fields) may be scrambled by a combined Challenge Key and Rotating Key (1004). The Observation Node may be configured to unscramble the ID, but not the body of the message. The scrambled body+ID+Challenge Key may then be transmitted to a network (e.g., a remote server) for processing (1006). The network server may maintain an image of the Rotating Key, and may further have a good idea what a pointer should have been for every transaction. By deducing a correct seed key, e.g., a Rotating Key or rotation code number, from the scrambled body+ID+Challenge Key (1008) (which may, for instance, be done by an exhaustive search and matching a cyclic redundancy check (CRC)), the network knows if there was a large skip in rotation numbers (1010, 1012). The distance of the new pointer from the old pointer indicates the likelihood that the tag was tempered with (1016) (wherein appropriate alarms could be generated in the network), or is a valid message (1014).

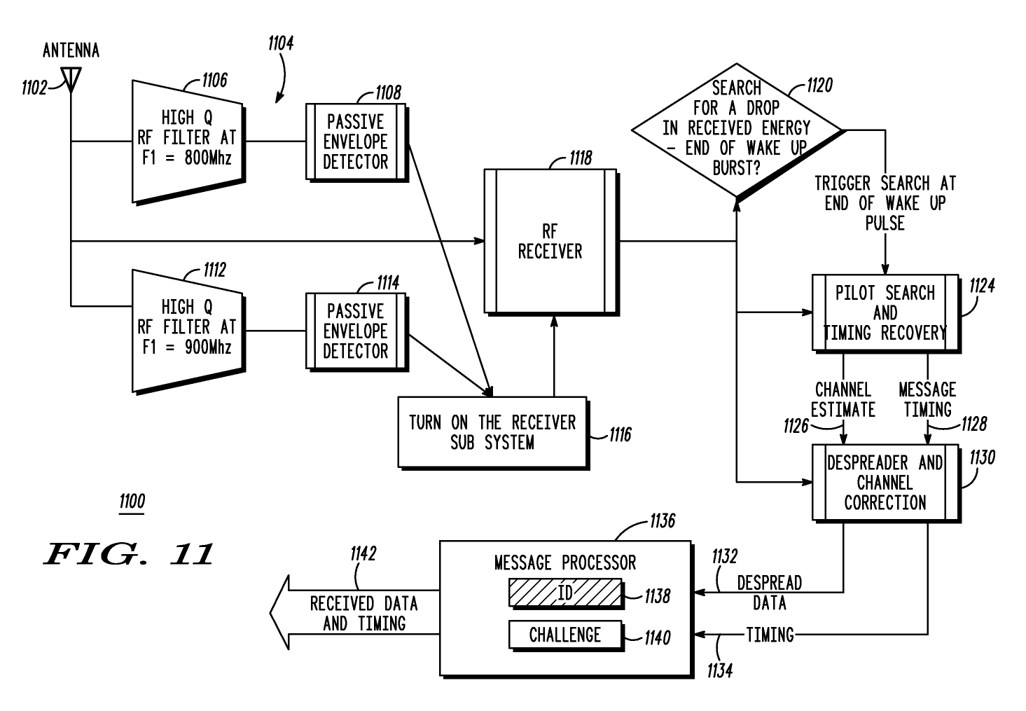

Turning now to FIG. 11, a tag device receiver structure (and some corresponding functionality) in accordance with embodiments herein is shown and generally indicated at 1100. The receiver may implement the link timing and waveforms described by reference to FIG. 3. The receiver 1100 typically comprises one or more antennas 1102 for receiving the excitation signals and transmitting data. The receiver front end may comprise one or more (two shown in this example) wake-up circuits 1104, 1110, each having a passive high-Q filter (respectively 1106, 1112) operatively coupled to an envelope detector circuit (respectively, 1108, 1114) using any suitable means. In this illustration, high-Q filter 1106 detects signals at a frequency F1 of about 800 MHz, while high-Q filter 1110 detects signals at a frequency F1 of about 900 MHz. These wake-up circuits detect respective excitation signals having sufficient energy (as defined by the envelop detector circuits) and having a predetermined frequency (as defined by the high-Q filters).

Accordingly, if sufficient energy is received in the designated bands, the output of the corresponding amplitude detector will be high enough to trigger a turn on circuit 1116, which may comprise for instance a comparator circuit to translate an RF voltage level to a digital logic level that could in turn cause a bi-stable device (commonly called a “flip-flop”) to latch and hold the detection of the wake-up signal. The turn on circuit 1116 may activate conventional receiver and digital portions (1118), turn on a clock and validate stability before allowing the receiver 1118 to start its receive functions (e.g., 1120-1142). Following the detection of sufficient signal strength and after waking up, the receiver 1100 looks for the excitation signal (e.g., the wake-up burst) to end (1120), thereby, marking the beginning of a delay period and triggering a search (1122), e.g., of pilot signals for enabling timing recovery.

A pilot search timing recovery circuit 1124 may further comprise the receiver 1100 and may be synchronized to the drop in energy, to minimize the amount of searching for timing recovery. Search and pilot recovery circuit 1124 outputs a channel estimate 1126 and message timing 1128 to a despreader and channel correction circuit 1130 that may further comprise the receiver 1100. The despreader and channel correction circuit 1130 may be configured, for example, to translate a wide band CDMA signal to a narrow band message (e.g., despread data 1132) and may further output timing data 1134. Circuits 1124 and 1130 may, for example, be implemented using a traditional correlator CDMA scheme. The despread and timing data 1132, 1134 may be input into a Message Processor 1136 further comprising the receiver 1100, where it may be used to retrieve data 1142 from the reader that may comprise, for example, a Reader ID 1138, a security challenge code 1140, and/or any other command parameter that may be present in a downlink message(s).

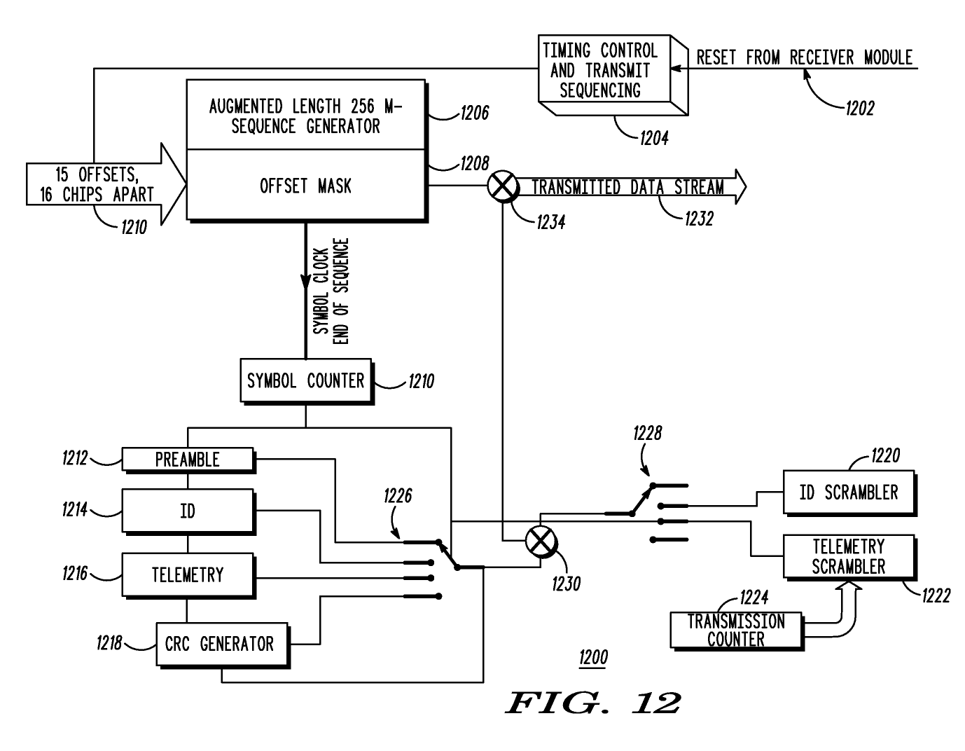

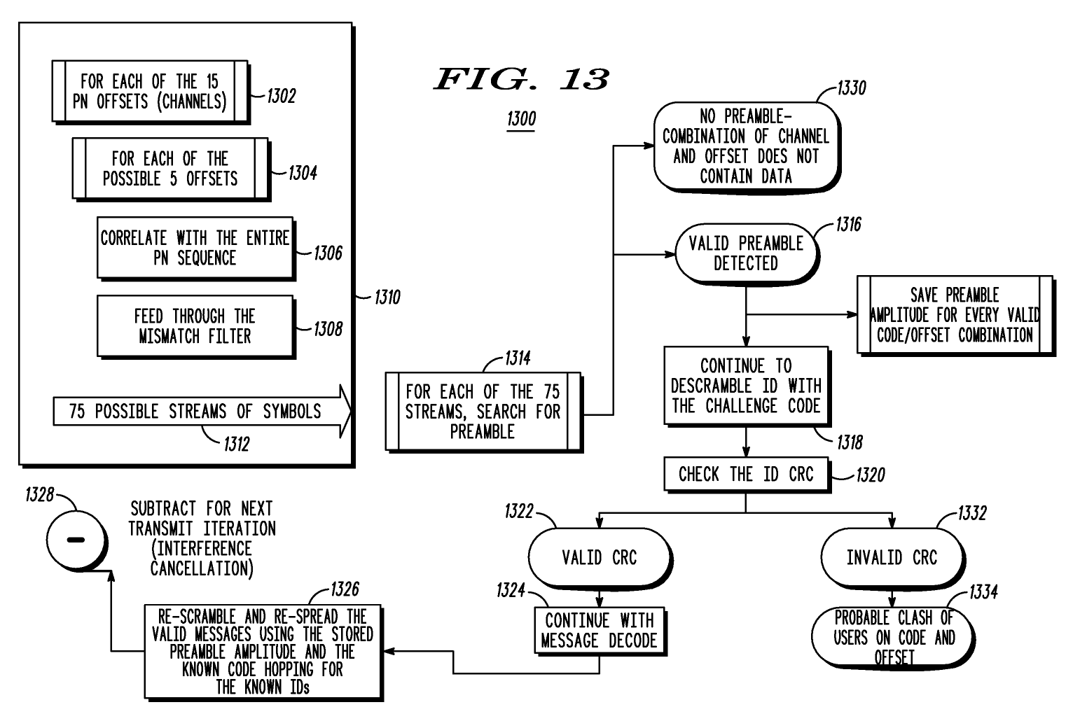

Turning now to FIG. 12, a tag device transmitter structure (and some corresponding functionality) in accordance with embodiments herein is shown and generally indicated at 1200. As can be seen in this embodiment, the transmit operation is started by the receiver (1202), after it was triggered and received both timing (Sync) and Challenge (Security), as was explained in detail above by reference to FIG. 11. For example, the transmitter 1200 may be turned on following the Sync pulse, provided the challenge message passed a successful CRC test. Once the transmitter is triggered, a timing and control unit 1204 takes over to sequence one or more different transmitter blocks. In one embodiment, all tag operations (both receive and transmit) may be implemented using a central 800 KHz clock, for instance, which corresponds to 800,000 Chips per Second CDMA operation.

The tag transmitter 1200 may further comprise an augmented length 256 M-sequence generator 1206, an offset mask 1208, and a summer 1234 all for controlling the number of times and the channel offset to be using to generate a transmitted data stream from one or more encrypted packets. The single (e.g., master) PN generator 1206 may be used to generate a 256 long augmented M sequence. The PN generator 1206 is typically reset before the beginning of a transmission, and the offset mask 1208 is used to generate 16 possible channel offsets 1210 for the PN generator 1206. The tag transmitter may further comprise a symbol counter 1210 that may by incremented each time the PN generator 1206 wraps around. This results in a symbol (character transmission) rate of 800,000/256 or 3125 symbols per second. If a binary phase-shift keying (BPSK) modulation is used to transmit for instance, it results in a ratio of 1 bit/symbol.

The tag transmitter 1200 may further comprise a preamble generator 1212, a tag identification generator 1214, a telemetry generator 1216 and a CRC generator 1218 to create the one or more packets for transmitting tag data to the reader device. A transmitted packet may have the following structure:

struct tx_packet {

| | | |
|---|---|---|
| tx_packet.preamble.agc | (1 symbol) | // adjust receiver AGC |
| tx_packet.preamble.timing | (1 symbol) | // timing recovery |
| tx_packet.id | (128 symbols) | // unique ID number, |
| tx_packet.telemetry | (512 symbols) | // tag data (if any) |
| tx_packet.CRC | (32 symbols) | // data integrity check |

} 676 symbols;

The tag transmitter further comprises an ID scrambler 1220 for encrypting the tag ID from ID block 1214, a telemetry scrambler 1222 for encrypting the tag telemetry data from telemetry block 1216, and a transmission counter 1224 for further encrypting the telemetry data. Tag transmitter 1200 also comprises switch sets 1226 and 1228 and summer 1230 to enable the encrypted packets to be formed, which are ultimately transmitted 1232. In one embodiment, the scrambler for the tag ID 1220 is based only on the security challenge, thereby enabling the Observation Node to decode the ID. However the telemetry data may be scrambled using a combination of the security challenge and the rotation key as described above. Assuming an 85% duty cycle, the number of packets that can be transmitted in a second is: 3125*0.55/676˜4. Where packets are repeated to increase the chances of the tag device information being heard and decoded by the reader device, for instance using a hopping scheme, a transmission may last about 5 seconds.

In order to resolve multiple tags using the same CDMA channel, the information may be repeated fifteen (15) times, each time using a different hopping scheme. In one embodiment, the hopping scheme may be appear to be random, but may also be based on the unique tag ID. This will minimize the likelihood that two tags will follow the exact same hopping sequence. A typical hopping generate can comprise a PN sequence generator, e.g., 1206, with the tag ID as a seed, generating channel numbers (4 bits) for the 15 retries, or in total 60 bits from a PN generator with the ID as a seed. These can be calculated on the fly, or stored in a pre-defined channel hopping matrix. The Observation Node reader may use interference cancellation to reconstruct the transmitted information.

For example, where four tags are present at a location, the channel hopping sequences may be as is shown in Table 1 below.

TABLE 1

| | | | | | | | | | | | | | | | |
|---|---|---|---|---|---|---|---|---|---|---|---|---|---|---|---|
| Tag 1 | 1 | 3 | 7 | 9 | 11 | 13 | 15 | 2 | 4 | 6 | 8 | 10 | 12 | 14 | 6 |
| Tag 2 | 1 | 9 | 3 | 11 | 15 | 12 | 2 | 6 | 8 | 4 | 14 | 13 | 5 | 7 | 9 |
| Tag 3 | 5 | 6 | 3 | 8 | 12 | 13 | 14 | 15 | 4 | 11 | 2 | 7 | 8 | 9 | 10 |
| Tag 4 | 1 | 9 | 7 | 2 | 3 | 4 | 5 | 6 | 15 | 8 | 10 | 11 | 12 | 13 | 14 |

As can be seen, tags 1, 2 and 4 transmit on the same CDMA channel during a first tag transmission pass. Consequently, only the data from tag 3 can be decoded. Accordingly, the transmissions of tags 1, 2, 4 to the reader failed the decode process on the first pass. However, once the data from tag 3 is decoded: the ID of tag 3 is known; the data of tag 3 is known; and the hopping sequence of tag 3 can be deduced. The reader receiver may save the receive amplitude of tag 3, so that on subsequent transmission iterations from the tag, the data of tag 3 can be cancelled (subtracted) from the received raw data, thereby improving system signal-to-interference. On a second transmission pass, tags 2 and 4 collide (both use code channel 9), but tag 1 can be decoded. Once decoded, its data can also be added to the interference cancellation circuit. As a result, from this point on tag 1 no longer interferes with other tags, even if they happen to use the same code channel in subsequent passes. On a third transmission pass, tags 2 and 4 do not collide with each other, but tag 4 collides with tag 1, and tag 2 collides with tag 3. However, tags 1 and 3 are already being cancelled due to prior decodes, so tags 4 and 2 can be successfully decoded, despite the collision.

Turning now to the reader device, it may comprise conventional transmitter circuitry as is well known in the art. However, in FIG. 13 a reader receiver structure (and some corresponding functionality) in accordance with embodiments herein is shown and generally indicated at 1300. Receiver 1300 comprises conventional receive circuitry (not shown) such as one or more antennas for receiving the tag data, a digital signal processor (DSP), etc. As can be seen, this illustrative receiver provides for single finger de-spreading for the 15 code channels 1302 and for five possible offsets 1304 associated with each of the main fingers. Thus, the receiver may comprise a total of 75 supported combinations of PN 256 correlators 1306 followed by 75 mismatch filters 1308 to generate seventy five possible streams of symbols 1312 from the received tag data, wherein simplicity of the finger design and a relatively slow chip rate simplify the filter design. Alternatively the raw samples from the tag data may be captured, and the receiver processing performed in software using a commercially available DSP.

The 75 possible symbol streams 1312 may be searched for a preamble 1314 (e.g., a known sequence). If a valid preamble is detected 1316, the receiver may demodulate and decode the tag ID. If the ID CRC is valid 1320, the packet may be considered valid 1322, the message decode may continue and data (e.g., telemetry) may be extracted. This data together with receive (RX) power, may be provided to an interference cancellation circuit 1326, 1328 and also transferred to the network (e.g., a remote server) for processing. In one embodiment, the reader receiver may re-scramble and re-spread the valid message using stored preamble amplitudes and known code hopping for the known tad IDs prior to subtracting the data during the next iteration.

One the other hand, if a stream fails because the preamble detect fails 1330 it likely corresponds to an empty code channel. Moreover, if the ID CRC check 1320 fails (e.g., an invalid CRC detected 1332), a collision or clash of users on that code and offset likely exists. Furthermore, timing for the reader receiver may be derived from the reader transmitter, such that a delay-locked loop (DLL) is not required to meet the system timing. This is possible due to the short range and multiple hypothesis processing for all possible offsets.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for enabling asset tracking comprising the steps of:
receiving a first excitation signal at a first power level using a first frequency band; and
upon determining that a first set of parameters is satisfied,
awakening from an inactive mode to an active mode,
transmitting data at a second power level that is greater than the first power level using a second frequency band that is different from the first frequency band, and
returning to the inactive mode,
wherein determining that the first set of parameters is satisfied comprises at least determining that the first excitation signal corresponds to a first wake-up circuit.

2. The method of claim 1, wherein the first excitation signal corresponds to the first wake-up circuit when the first frequency band comprises a predetermined frequency band corresponding to the first wake-up circuit, and the first power level one of exceeds a predetermined threshold corresponding to the first wake-up circuit and is with a predetermined range corresponding to the first wake-up circuit.

3. The method of claim 2, wherein the second frequency band is lower than the first frequency band.

4. The method of claim 3, wherein the first frequency band in within at least one of an 800 MHz frequency band and a 900 MHz frequency band, and the second frequency band is within one of a 433 MHz frequency band.

5. The method of claim 1, wherein determining that the first set of parameters is satisfied further comprises determining that the first wake-up circuit has not been deactivated.

6. The method of claim 5, wherein if the first wake-up circuit has been deactivated, remaining in the inactive mode when the first excitation signal corresponds to the first wake-up circuit.

7. The method of claim 1, wherein the first wake-up circuit is one of a plurality of wake-up circuits.

8. The method of claim 7 further comprising the step of receiving an instruction signal comprising an instruction to inactivate all but one of the plurality of wake-up circuits.

9. The method of claim 8 further comprising the step of receiving a second excitation signal corresponding to a wake-up that has been deactivated and remaining in the inactive mode.

10. The method of claim 1, wherein the data is transmitted on a first channel selected from a plurality of channels.

11. The method of claim 10, wherein the first channel is selected using a random number process.

12. Apparatus comprising:
an antenna
a receiver circuit coupled to the antenna and comprising at least one wake-up circuit, the receiver circuit,
receiving a first excitation signal at a first power level using a first frequency band; and
upon determining that a first set of parameters is satisfied, awakening from an inactive mode to an active mode, transmitting data at a second power level that is greater than the first power level using a second frequency band that is different from the first frequency band, and returning to the inactive mode, wherein determining that the first set of parameters is satisfied comprises at least determining that the first excitation signal corresponds to the at least one wake-up circuit; and
a transmitter circuit coupled to the antenna and to the receiver circuit to transmit the data.

13. The apparatus of claim 12, wherein the receiver circuit comprises a plurality of wake-up circuits to awaken the tag device, each wake-up circuit in the plurality being activated by a different excitation signal.

14. The apparatus of claim 13, wherein each wake-up circuit in the plurality is activated by a different corresponding frequency band used to receive its corresponding excitation signal, and each wake-up circuit comprises a Q-filter for controlling its corresponding frequency band.

15. The apparatus of claim 14, wherein the receiver comprises:
a first wake-up circuit comprising a first Q-filter coupled to a first envelop detection circuit for detecting an excitation signal received using an 800 MHz frequency band for activating the first wake-up circuit; and
at least a second wake-up circuit comprising a second Q-filter coupled to a second envelop detection circuit for detecting an excitation signal received using a 900 MHz frequency band for activating the second wake-up circuit.

16. The apparatus of claim 12 further comprising a random number generator for selecting one of a plurality of channels for transmitting the data.

17. A method for enabling asset tracking comprising the steps of:
receiving a first excitation signal at a first power level using a first frequency band; and
upon determining that a first set of parameters is satisfied,
awakening from an inactive mode to an active mode,
transmitting data at a second power level that is greater than the first power level using a second frequency band that is different from the first frequency band, and
returning to the inactive mode,
wherein determining that the first set of parameters is satisfied comprises at least determining that the first excitation signal corresponds to a first wake-up circuit of a plurality of wake-up circuits.
